(19) United States
(12) Patent Application Publication
(10) Pub. No.: US 2024/0207820 A1
(43) Pub. Date: Jun. 27, 2024

(54) HYDROTHERMAL ALKALINE TREATMENT OF PFAS-CONTAMINATED ADSORBENTS FOR CONTAMINANT MINERALIZATION AND ADSORBENT REGENERATION

(71) Applicant: COLORADO SCHOOL OF MINES, Golden, CO (US)

(72) Inventors: Timothy J. Strathmann, Golden, CO (US); Christopher P. Higgins, Golden, CO (US); Ori Soker, Lakewood, CO (US); Shilai Hao, Lakewood, CO (US)

(21) Appl. No.: 18/479,419

(22) Filed: Oct. 2, 2023

Related U.S. Application Data
(60) Provisional application No. 63/378,198, filed on Oct. 3, 2022.

(51) Int. Cl. B01J 20/34; B01J 20/20; C02F 1/28; C02F 101/36

(52) U.S. Cl. CPC B01J 20/3475; B01J 20/20; B01J 20/3416; B01J 20/3483; C02F 1/283; C02F 2101/36; C02F 2303/16

(57) ABSTRACT

Herein disclosed are compositions, methods, and systems useful for treating PFAS- contaminated adsorbents to simultaneously achieve mineralization of adsorbed per- and polyfluoroalkyl substances and regenerate the adsorbent materials to enable re-use of the materials. This is accomplished by applying subcritical hydrothermal reaction conditions together with solution amendments to promote PFAS destruction while minimizing alterations of the adsorbent materials. The process requires much lower energy input than existing thermal disposal or regeneration technologies. The milder liquid phase treatment conditions allow for treatment and regeneration of a wider range of adsorbent materials being deployed for PFAS treatment.

### GOVERNMENT LICENSE RIGHTS

This invention was made with Government support under ER18-1501 awarded by the U.S. Department of Defense. The Government has certain rights in the invention.

### CROSS-REFERENCE TO RELATED APPLICATIONS

This application claims benefit of priority pursuant to 35 U.S.C. § 119(e) of U.S. provisional patent application No. 63/378,198 entitled “HYDROTHERMAL ALKALINE TREATMENT OF PFAS-CONTAMINATED ADSORBENTS FOR CONTAMINANT MINERALIZATION AND ADSORBENT REGENERATION,” filed on 3 Oct. 2022, which is hereby incorporated by reference in its entirety.

### FIELD

The disclosed processes, methods, and systems are directed to destruction of PFAS contaminating adsorbent material and simultaneous regeneration of that material for re-use as an adsorbent media.

### BACKGROUND

Currently, most full-scale treatment processes for water contaminated with per- and polyfluoroalkyl substances (PFAS) involve the application of adsorbent materials, most often granular activated carbon (GAC) and ion exchange resins, but other adsorbents are also being actively developed to treat PFAS-contaminated water sources. However, weak PFAS adsorption and PFAS breakthrough from adsorbent beds is often observed. This necessitates frequent replacement of the adsorbent media.

Adsorbents are not inexpensive, and their frequent replacement, combined with management of the PFAS-contaminated media (e.g. landfill, incineration, etc.) can be cost-prohibitive. Existing products and processes include conventional off-site thermal regeneration of granular activated carbon (GAC), and off-site incineration of GAC and ion exchange resins. Use of supercritical water oxidation of some PFAS-contaminated adsorbents has also been demonstrated, but this process completely destroys the adsorbent with the PFAS.

Therefore there is an urgent need for effective and economical processes for (a) destroying PFAS that accumulate on the adsorbent materials and (b) regenerating the adsorbents so that they can be re-used rather than landfilled, incinerated or otherwise disposed.

### BRIEF DESCRIPTION OF THE DRAWINGS

FIG. 1 is a graph of data from defluorination and removal of PFOS using one embodiment of the presently described processes. Reaction conditions were 1 M NaOH, 350° C., and samples taken and plotted from 0 to 400 minutes.

FIG. 2 is a bar graph showing results from one embodiment of the disclosed process to remove of PFASs adsorbed to GAC used in a pilot study. Conditions: 1 M NaOH, 350° C., 400 minutes.

FIG. 3 is a Langmuir Isotherm for PFPeA on (1) regenerated GAC using one embodiment of the disclosed process and (2) virgin GAC. Conditions for regeneration of GAC in this embodiment: 1 M NaOH, 350° C., 240 minutes.

FIG. 4 is a phase diagram showing the conditions required for one embodiment of the present process, which occurs near the critical point for water.

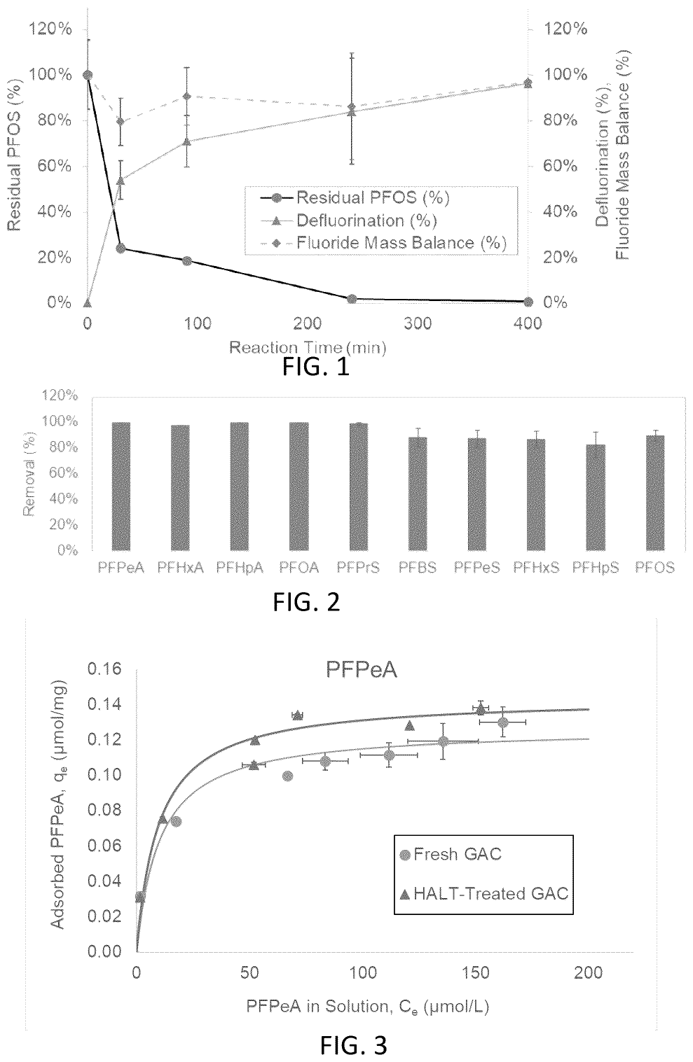

### DETAILED DESCRIPTION

Disclosed herein is a hydrothermal treatment process involving milder conditions than existing incineration and thermal regeneration processes used to treat PFAS-contaminated adsorption media. These milder conditions lower required energy inputs while simultaneously destroying the PFAS and maintaining PFAS-attracting properties of the material. This allows for regeneration and reuse of the material. The lower temperatures and use of a liquid phase process also offers the potential for on-site treatment and regeneration. Performing the process on site would further reduce costs by eliminating expenses and liabilities associated with shipping PFAS-contaminated media off site for regeneration or disposal.

Applicants previously developed hydrothermal alkaline treatment process for PFAS destruction and mineralization, that could be used to treat PFAS-contaminated liquid, soil, and wastewater biosolids matrices. While that process was effective, it was not applicable to most existing treatments, which involve the use of adsorbents. Disclosed herein are compositions, methods, and systems applicable to those existing treatment regimen, wherein the present compositions, methods, and systems directly treat PFAS-contaminated adsorbent materials, while maintaining the adsorbent materials' reusability. Use of sorbents like granular activated carbon (GAC) and ion exchange resins are the predominant technology currently in use for treating PFAS-contaminated water, necessitating costly media replacement and off-site management of the adsorbent material.

Per- and polyfluoroalkyl substances (PFASs), are a family of chemicals developed in the 1940s with applications ranging from nonstick coatings and food packaging to aqueous film-forming foams. PFASs are the focus of growing attention in recent years because of the adverse health effects associated with exposure to some of these compounds, even at low levels. Because of their long and widespread use, PFASs have been detected throughout the environment, including in drinking water sources. As a result, PFAS exposure has emerged as a complex public health challenge, requiring innovative management and treatment approaches.

Currently, ion exchange and granular activated carbon (GAC) are widely used for PFAS removal in drinking water treatment applications. Both media types reduce PFAS concentrations via adsorption, meaning that the dissolved PFAS compounds are transferred from a liquid to a solid phase. Despite the high PFAS removal achieved by these adsorption-based treatment processes, they suffer from limited adsorption capacity. Once a GAC or ion exchange resin reaches this capacity, the spent material is unable to remove any more PFASs and must be safely disposed of or regenerated. In the case of GAC, which is temperature-stable, thermal regeneration above 700° C. has been shown to achieve high PFAS destruction. However, this is a costly and energy-intensive process requiring the evaporation of all water absorbed by the spent GAC in addition to the high temperature conditions. Furthermore, thermal regeneration diminishes the specific surface area and micropore volume of the GAC, potentially leading to reduced performance during reuse.

Per- and polyfluoroalkyl substances (PFASs) continue to pose substantial risks to environments and human health, making effective treatment approaches a priority. Using strongly basic water at temperatures and pressures near the critical point, hydrothermal alkaline treatment has been shown to degrade and mineralize PFASs in water and aqueous soil slurries. Surprisingly, Applicants herein demonstrate that similar methods may be useful in treatment and regeneration of PFAS-adsorbing media, for example granular activated carbon (GAC) sorbents loaded with PFASs. Herein, Applicants show that the present methods and systems may result in over 99% removal of PFOS and 96.2±0.4% defluorination. In one embodiment, the disclosed methods and processes may comprise treating contaminated media with a base, for example about 1.0 M NaOH, at elevated temperatures, for example about 350° C., for various times, for example about 400 min. Also described is use of the disclosed processes and systems on field-spent GAC, demonstrating effective treatment of a wide range of perfluoroalkyl acids. Surprisingly, virgin GAC and GAC treated with the disclosed processes had similar adsorption isotherms for perfluoropentanoic acid (PFPeA), indicating that the adsorbent was stable during treatment.

Described herein are compositions, methods, and systems for destruction of per-and polyfluoroalkyl substances (PFAS) and halogenated organic co-contaminants adsorbed on solid media, for example media used to remove PFAS from contaminated water or gas streams. Adsorption technologies, including granular activated carbon (GAC) and ion exchange (IX), are the most commonly used process for treating water supplies contaminated by PFAS. However, upon saturation of available adsorbent surface sites, PFAS begin to breakthrough into the effluent of adsorbent reactors, necessitating replacement of the exhausted media. Frequent replacement of adsorption media and management of the contaminated media being replaced can be costly.

As disclosed herein, hydrothermal reaction conditions (condensed phase water at temperatures ranging from 150 Celsius to 374 degrees Celsius) may be applied together with alkali amendments (sodium hydroxide, potassium hydroxide, magnesium hydroxide, calcium hydroxide, ammonia) and organic co-solvents (methanol, ethanol, n-propanol, isopropanol, butanol, ethylene glycol, propylene glycol, acetone, ketones) to degrade and dehalogenate PFAS and other halogenated contaminants that are adsorbed on media. The present processes and reaction conditions (temperature, amendment composition, reaction time) can be tailored to promote destruction of the adsorbed contaminants with minimal or no change to the media. This allows for re-use of the treated adsorption media.

Various parameters may be used to achieve destruction of the PFOS and regeneration of the adsorbent media. In various embodiments, the temperature is between about 150 and 374 degrees Celsius, and the alkaline substance is sufficient to achieve a pH of 12 or higher for the combination, and the time at elevated temperature and pressure may be greater than about 60 seconds. In other embodiments, process temperature, pH, alkaline substance, pressure, and time may vary depending on the individual PFAS to be targeted. In some embodiments, PFAS destruction and media regeneration may require higher temperatures, alkali concentrations, and reaction times, while other PFAS require lesser temperatures, concentrations, and times.

### Adsorption Media

Various adsorption media can be treated with the disclosed compositions, methods, and systems. In one embodiment, the treated media may be selected from activated carbons (both granular and powder forms), ion exchange resins, organo clay adsorbents, cyclodextrin polymers, and other adsorbents in development for PFAS treatment applications.

### System Location and Configuration

PFAS-contaminated adsorbents can be treated either on-site or off-site. In one embodiment, the treatment system may be located away from the location where PFAS is combined with the adsorbent material—for example at a centralized facility designed eliminate PFAS contamination and regenerate media for re-use. In these cases, the centralized facility may treat contaminated media from various locations. In many embodiments, the disclosed systems may be variously configured. Without being limited to the following, an embodiment of the disclosed reactor be configured for:
(1) Treatment of packed bed media in place where the same reactor used for adsorption is sealed with liquid amendments and heated to the design conditions for a sufficient period of time to reach treatment targets before rinsing the packed be to remove residual amendments and treatment residuals before returning the media to use as an adsorbent.
(2) Treatment of packed bed media where hydrothermal fluid is continuously flowed through the reactor bed for the desired reaction time to meet treatment targets.
(3) Moving bed regenerable treatment system where a portion of contaminated media, usually media from the more contaminated influent end of the packed bed, is continuously or intermittently transferred from the adsorbent bed to a smaller hydrothermal reactor and treated. Following treatment, the treated media is returned to the effluent end adsorbent bed.
(4) Fluidized bed reactor where spent media is fluidized in appropriate hydrothermal fluid until treatment targets are met.
(5) Stirred slurry of adsorbent media treated with hydrothermal media, either in batch or continuous-flow mode until treatment targets are reached.
(6) Flowing slurry reactor where slurries of spent media prepared in the appropriate fluid are flowed through the hydrothermal temperature zone of a continuous flow reactor, either in a single pass or multiple passes to accomplish reaction.

### Temperature

The disclosed processes may occur at various temperatures. In most embodiments, the process temperature may be between about 100° C. and 400° C., for example 150° C.-374° C.. In one embodiment the temperature may be about 350° C.. In various embodiments, the temperature is greater than about 100° C., 110° C., 120° C., 130° C., 140° C., 150° C., 160° C., 170° C., 180° C., 190° C., 200° C., 210° C., 250° C., 260° C., 280° C., 300° C., 310° C., 320° C., 330° C., 340° C., 350° C., 360° C., 370° C., 380° C., 390° C., or 400° C., and less than about 410° C., 400° C., 390° C., 380° C., 370° C., 360° C., 350° C., 340° C., 330° C., 320° C., 310° C., 300° C., 290° C., 280° C., 270° C., 260° C., 250° C., 250° C., 230° C., 220° C., 210° C., 200° C., 190° C., 180° C., 170° C., 160° C., 150° C., 140° C., 130° C., 120° C., or 110° C..

In many embodiments, the temperature within the reactor is selected to achieve the critical state of water and may be referred to as the process temperature. The process temperature may be maintained from about 60 s to about 500 min. In various embodiments, the process time/duration may depend upon temperature, alkaline concentration, PFAS, etc.

### Alkaline Substances

Various alkaline substances may be combined with PFAS-contaminated adsorbent material to regenerate the adsorbent media. In many embodiments, the alkaline substance is selected from sodium hydroxide, potassium hydroxide, magnesium hydroxide, calcium hydroxide, and ammonia. Various concentrations of alkaline substance may be added. In most embodiments, the concentration is greater than about 0.01 M, 0.05 M, 0.1 M, 0.2 M, 0.3 M, 0.4 M, 0.5 M, 0.6 M, 0.7 M, 0.8 M, 0.9 M, 1.0 M, 1.1 M, 1.2 M, 1.3 M, 1.4 M, 1.5 M, 1.6 M, 1.7 M, 1.8 M, 1.9 M, 2.0 M or more, and less than about 5 M, 4 M, 3 M, 2 M, 1.9 M, 1.8 M, 1.7 M, 1.6 M, 1.5 M, 1.4 M, 1.3 M, 1.2 M, 1.1 M, 1.0 M, 0.9 M, 0.8 M, 0.7 M, 0.6 M, 0.5 M, 0.4 M, 0.3 M, 0.2 M, 0.1 M, or 0.05 M. In many embodiments, the amount of alkaline substance is sufficient to achieve a pH of between 10 and 14, for example greater than about pH 9, pH 10, pH 11, pH 12, or pH 13, and less than about pH 14, pH 13, pH 12, pH 11, or pH 10. In many embodiments, the pH is greater than 13. In most embodiments, the pH is greater than 12.

In various embodiments the alkaline substance is combined with the contaminated material before it is added to a reactor. In other embodiments the alkaline substance is added to the reactor before or after the contaminated material is added. In some embodiments, the alkaline substance is heated to the process temperature before being combined with the contaminated adsorbent media.

### Co-Solvents

Various co-solvents may be combined with the alkaline substance and the PFAS-contaminated adsorbent material. In many embodiments, the co-solvent is an organic co-solvent, for example an organic co-solvent selected from methanol, ethanol, n-propanol, isopropanol, butanol, ethylene glycol, propylene glycol, acetone, and ketone.

### Methods

The disclosed processes may be practiced in various forms and configurations. As noted above, the process includes batch, stream, and continuous processing. In some embodiments, the reactor used to process the contaminated adsorbent material to regenerate adsorbent media, may also be used to capture PFAS from a liquid stream by adsorption onto the regenerated adsorbent media.

The Examples below, describe various embodiments for destruction of PFAS on a media and regeneration of the adsorbent media. In many embodiments, the disclosed methods and systems may be useful in destruction and defluorination of PFAS, including perfluorooctane sulfonate (PFOS), adsorbed onto GAC. The disclosed PFAS degradation, defluorination, is accomplished while retaining PFAS adsorption characteristics of the GAC. In one embodiment, PFAS-contaminated GAC may be treated using water amended with sodium hydroxide with application of heat to 350 degrees Celsius.

Cost-effectiveness and sustainability both remain key obstacles to PFAS treatment. For this reason, it is important to focus on technologies that have the potential to enhance treatment and removal while decreasing energy and material use. Disclosed herein are compositions, process, and methods useful in GAC regeneration and destruction of adsorbed PFASs. The disclosed processes are effective at preserving adsorption capacity of adsorbent media.

### EXAMPLES

### Example 1—Fluoride Mass Balance as Evidence for PFOS Destruction

### Materials & Methods

Spent GAC was generated using a solution containing a predetermined mass of PFOS in salt form, to which a known mass of Calgon F400 GAC—the adsorbent used in this study—was added. Some experiments used field-spent GAC samples from a previous pilot study. Hydrothermal reactions took place in 316 Stainless Steel reactors containing 500 mg of spent GAC and 3.0 mL of liquid; this liquid was a basic solution of Milli-Q water containing varying amounts of NaOH. A fluoride ion-selective electrode was used to quantify fluoride release into reactor liquid for defluorination calculations. To determine adsorbed PFAS concentrations before and after processing, extractions with methanol and 100 mmol/L ammonium acetate were performed, desorbing PFASs from the GAC. Then, isotherms were generated to compare the adsorption capacity of F400 GAC for PFPeA before and after one embodiment of the present process: 240 minutes at 350° C. with 1.0 M NaOH. These experiments involved adding varying amounts of GAC to centrifuge tubes containing a known concentration of PFPeA. Adsorption capacity was calculated from the resulting data using a Langmuir isotherm model. Quantification of PFASs was accomplished using LC/MS-MS.

Results from the present experiments, using GAC pre-loaded with PFOS, are presented in FIG. 1. In the system containing GAC, over 99% PFOS removal and 96.2±0.4% defluorination were achieved following treatment using one embodiment of the presently disclosed process—400 minutes at 350° C. using 1 M NaOH.

LC-MS/MS results for PFOS and perfluoroheptanesulfonate (PFHpS)—an impurity in the PFOS salt—detected in GAC extracts and reactor liquid were used to calculate fluorine equivalents remaining in the reaction system. Using these values, a fluorine mass balance was constructed by adding the remaining fluorine equivalents from LC-MS/MS analysis and fluoride detected in the diluted reactor liquid. Given that this mass balance remained at or near 100%, as well as the lack of fluorinated organic intermediates detected in GAC extracts and reactor liquid, it can be concluded that adsorbed PFOS is fully defluorinated.

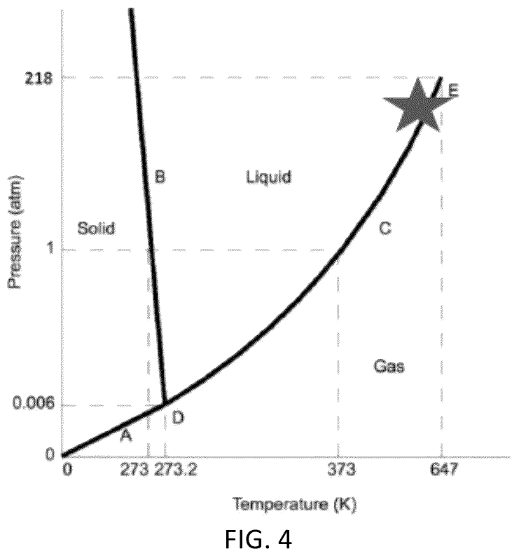

A set of liquid-only reactions were run using PFOS to evaluate the effect of GAC on the presently disclosed processes. The reactor liquid, which contained a PFOS solution combined with NaOH, had 1 M NaOH overall; this allowed for a consistent comparison between the GAC and liquid-only reaction system. Results for these experiments, which suggested somewhat faster reaction rates in the absence of GAC, are shown in FIG. 4. However, given PFOS's partitioning behavior into GAC and its limited solubility in water, the use of the present process on spent GAC allowed for a significantly higher mass loading of PFOS into reactors. Consequently, while the GAC-free reaction system achieved over 99% destruction of PFOS in far less time than the GAC-containing system, the spent GAC—which had a much greater initially adsorbed mass of PFOS—yielded for a higher rate of PFOS destruction by mass. Calculations supporting these conclusions are available below.

### Example 2—Removal of PFASs Adsorbed to Field-Spent GAC

Samples of F400 GAC used in a pilot study were also treated with GAC to determine whether treatment outcomes were consistent with spent GAC generated in the lab; these experiments also allowed for analysis of the fate of a wider range of adsorbed PFASs.

Perfluoroalkyl carboxylic acids (PFCAs) were removed to a significantly higher extent than most perfluoroalkyl sulfonates (PFSAs) following 400 minutes at 350° C. with 1 M NaOH. Only PFHxA was detected in two replicate samples of treated GAC extracts; however, the low concentrations were similar to that of blanks, so the detection may have been a result of contamination. As for the sulfonates, removal ranged from 82±10% for PFHpS to 99±1% for perfluoropropanesulfonate (PFPrS). PFOS removal was 90±4%, suggesting that the field-spent GAC contained other constituents that decreased the efficacy of the present processes, perhaps by consuming the hydroxide.

### Example 3—PFPeA Isotherms

Langmuir isotherms for PFPeA are shown in FIG. 4, and demonstrate that adsorption capacity of treated GAC was comparable to that of virgin GAC. Rather than causing decreased adsorption behavior, it appeared that adsorption was slightly enhanced by the disclosed processes. This is supported by the maximum adsorption capacities for GAC regenerated with the present process and virgin GAC material, which were found to be 0.144±0.004 and 0.127±0.007 μmol/mg, respectively. Given the temperatures and pH conditions used in some embodiments of the present process, it was particularly promising that the process did not noticeably disrupt adsorption behavior, allowing for possible GAC reuse in PFAS treatment applications. Compared to thermal regeneration, the presently disclosed processes appear to preserve material quality while destroying PFASs, and do so at far lower temperatures, leading to reduced energy requirement.

### Generation of Spent GAC

A solution containing perfluorooctanesulfonate (PFOS) was prepared by adding the solid potassium salt of PFOS to 990 mL of Mill-Q water with 5 mM NaCl and 1 mM NaHCO3. 10 mL of methanol was added to promote dissolution of the PFOS salt. 250 ml of the well-mixed PFOS solution was transferred to a Pyrex bottle, to which 5.0 g of Calgon F400 GAC was added. The GAC was left to equilibrate with the PFOS solution for three days, after which the liquid was removed, and the spent GAC was dried in an oven at 80° C. for two days. Liquid samples were taken before and after adsorption to determine the mass loading of PFOS on the GAC.

### Hydrothermal Reactions

All hydrothermal reactions were carried out in reactors made of 316 Stainless Steel parts purchased from Swagelok. Except for liquid-only reactions, each reactor contained 500 mg of GAC and 3.0 mL of liquid. The liquid added to the reactor was a basic solution of Milli-Q water containing NaOH.

For liquid-only experiments, 2.0 mL of PFOS spike solution were added to 1.0 ml of Milli-Q water with 3 M NaOH. The overall concentration of NaOH in the basic solution was the same for the liquid-only system and a comparable reactor containing PFOS-loaded GAC, which used 3.0 mL of 1 M NaOH.

To achieve subcritical conditions, sealed reactors were placed in a sand bath operating at the reaction temperature. The reaction time began after four minutes in the sand bath, which was calculated as the time needed to heat reactor contents to the sand bath temperature.

Following the specified reaction time, reactors were quenched in water and their contents were emptied into a 50 mL centrifuge tube. GAC remaining inside the reactor was taken out using Milli-Q water and added to the centrifuge tube. Tube contents were vortexed, after which supernatant was transferred a 15 mL centrifuge tube for fluoride measurement and LC-MS/MS analysis. The GAC in the centrifuge tube was then dried at 80° C. for two days in preparation for PFAS extraction.

### Fluoride Measurement

A fluoride ion-selective electrode was used to quantify fluoride release into reactor liquid. The sample analyzed was the diluted reactor liquid—the liquid reactor contents diluted by the Milli-Q water used for GAC recovery.

### PFAS Extraction from Spent GAC

Multiple extractions with methanol and 100 mmol/L ammonium acetate were used to desorb PFASs from GAC. These liquid extracts could then be sampled for LC-MS/MS analysis.

After removal from the oven, 150 mg of GAC were transferred to a 50 mL centrifuge tube. 24 mL of methanol and 1 mL of aqueous 100 mM ammonium acetate were added to the tube, which was placed on the shaker table at 120 rpm for 24 hours. The supernatant was removed from the centrifuge tube after it was taken off the shaker table, leaving minimal liquid in contact with the GAC. Two additional extraction steps were performed by repeating the procedure twice, starting with the methanol and ammonium acetate addition, which generated 75 mL of liquid in total for a 150 mg portion of GAC. Aliquots from the three25-mL extracts were blended in equal proportions prior to dilution and analysis. For the field-spent GAC, which contained a much lower PFAS content, two extraction steps were used, generating a 50 mL extract.

### Isotherm Experiments

Isotherms were generated to compare the adsorption capacity of Calgon F400 GAC for PFPeA before and after treatment with one embodiment of the presently disclosed process: 240 minutes at 350° C. with 1.0 M NaOH. PFPeA solutions were made and added to identical containers along with specified amounts of GAC. Virgin GAC was added to one group of containers, whereas treated GAC was added to the other.

### PFAS Analysis

Quantification of PFASs was accomplished with LC/MS-MS using a X500R QTOF system.

### Comparison of liquid-only and GAC-containing reactions

A reaction system without GAC achieved faster PFOS percent removal and defluorination than the system containing GAC. Following 90 minutes at 350° C. with 1 M NaOH, the liquid-only reaction removed 98% of the initial PFOS. This is substantially higher than the 81±2% removal of PFOS adsorbed to GAC under these conditions.

However, it is important to note that the GAC allowed for a much higher PFOS-loading in the reactor. The PFOS-loaded GAC used in the 90-minute reaction contained 10±2 mg/g of PFOS initially, meaning that a reactor with 500 mg GAC contained approximately 5±1 mg of PFOS. In comparison, the liquid-only reactions used 3.0 mL of a 56±6 mg/L solution of PFOS, meaning that the reactors were loaded with less than 0.2 mg of PFOS; this is approximately 50 times less PFOS than the reactors containing spent GAC. Consequently, the reactions using adsorbed PFOS achieved a higher overall destruction rate in terms of PFOS mass destroyed per unit time. At 90 minutes, for example, no more than 0.2 mg of dissolved PFOS could be removed and defluorinated, whereas several milligrams of adsorbed PFOS were already destroyed by this point.

### REFERENCES

1 Sunderland, E. M.; Hu, X. C.; Dassuncao, C.; Tokranov, A. K.; Wagner, C. C.; Allen, J. G. A Review of the Pathways of Human Exposure to Poly- and Perfluoroalkyl Substances (PFASs) and Present Understanding of Health Effects. J Expo Sci Environ Epidemiol 2019, 29 (2), 131-147. doi.org/10.1038/s41370-018-0094-1.
2 Yadav, S.; Ibrar, I.; Al-Juboori, R. A.; Singh, L.; Ganbat, N.; Kazwini, T.; Karbassiyazdi, E.; Samal, A. K.; Subbiah, S.; Altaee, A. Updated Review on Emerging Technologies for PFAS Contaminated Water Treatment. Chemical Engineering Research and Design 2022, 182, 667-700. doi.org/10.1016/j.cherd.2022.04.009.
3 Fang, Y.; Ellis, A.; Choi, Y. J.; Boyer, T. H.; Higgins, C. P.; Schaefer, C. E.; Strathmann, T. J. Removal of Per- and Polyfluoroalkyl Substances (PFASs) in Aqueous Film-Forming Foam (AFFF) Using Ion-Exchange and Nonionic Resins. Environ. Sci. Technol. 2021, 55 (8), 5001-5011. doi.org/10.1021/acs.est. 1c00769.
4 Xiao, F.; Sasi, P. C.; Yao, B.; Kubátová, A.; Golovko, S. A.; Golovko, M. Y.; Soli, D. Thermal Stability and Decomposition of Perfluoroalkyl Substances on Spent Granular Activated Carbon. Environ. Sci. Technol. Lett. 2020, 7 (5), 343-350. doi.org/10.1021/acs.estlett.0c00114.
5 Sonmez Baghirzade, B.; Zhang, Y.; Reuther, J. F.; Saleh, N. B.; Venkatesan, A. K.; Apul, O. G. Thermal Regeneration of Spent Granular Activated Carbon Presents an Opportunity to Break the Forever PFAS Cycle. Environ. Sci. Technol. 2021, 55 (9), 5608-5619. doi.org/10.1021/acs.est.0c08224.
6 Wu, B.; Hao, S.; Choi, Y.; Higgins, C. P.; Deeb, R.; Strathmann, T. J. Rapid Destruction and Defluorination of Perfluorooctanesulfonate by Alkaline Hydrothermal Reaction. Environ. Sci. Technol. Lett. 2019, 6 (10), 630-636. doi.org/10.1021/acs.estlett.9b00506.
7 Hao, S.; Choi, Y.-J.; Wu, B.; Higgins, C. P.; Deeb, R.; Strathmann, T. J. Hydrothermal Alkaline Treatment for Destruction of Per- and Polyfluoroalkyl Substances in Aqueous Film-Forming Foam. Environ. Sci. Technol. 2021, 55 (5), 3283-3295. doi.org/10.1021/acs.est.0c06906.
8 Murray, C. C.; Marshall, R. E.; Liu, C. J.; Vatankhah, H.; Bellona, C. L. PFAS Treatment with Granular Activated Carbon and Ion Exchange Resin: Comparing Chain Length, Empty Bed Contact Time, and Cost. Journal of Water Process Engineering 2021, 44, 102342. doi.org/10.1016/j.jwpe.2021.102342.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

All references disclosed herein, whether patent or non-patent, are hereby incorporated by reference as if each was included at its citation, in its entirety. In case of conflict between reference and specification, the present specification, including definitions, will control.

Although the present disclosure has been described with a certain degree of particularity, it is understood the disclosure has been made by way of example, and changes in detail or structure may be made without departing from the spirit of the disclosure as defined in the appended claims.

1. A method for treating a regenerating an adsorbent media, the method comprising:
placing a composition comprising a PFAS-contaminated adsorbent material in a reactor;
introducing an alkaline substance into the reactor with the PFAS-contaminated adsorbent material;
sealing the reactor to from ingress or egress of gas;
increasing the temperature within the reactor;
maintaining an elevated temperature for a time sufficient to at least partially mineralize the PFAS and generate an adsorbent material substantially free of PFAS; and
separating the adsorbent media from the mineralized PFAS.

2. The method of claim 1, wherein the temperature is increased to greater than about 200° C. to less than about 500° C.

3. The method of claim 1, wherein the temperature and pressure within the reactor are at the critical point of water.

4. The method of claim 3, wherein the absorbent media is selected from granular activated carbon, powdered activated carbons, ion exchange resin, organo clay adsorbent, polymers, and cyclodextrin polymer.

5. The method of claim 4, wherein the absorbent media is activated carbon.

6. The method of claim 5, wherein the alkaline substance is at least one of NaOH, Ca(OH)₂, Na₂CO₃, KOH, NH₄OH, Mg(OH)₂.

7. The method of claim 6, wherein the alkaline substance is NaOH.

8. The method of claim 7, wherein a co-solvent is added to the reactor wherein the co-solvent is selected from methanol, ethanol, n-propanol, isopropanol, butanol, ethylene glycol, propylene glycol, acetone, and ketones.

9. A system for regenerating an absorbent material comprising:
a reactor adapted to:
combine a composition comprising an adsorbent material and PFAS with an alkaline substance;
heat the combination to a temperature of greater than about 200° C. and less than about 500° C.;
maintain a pressure within the reactor of about 220 atmospheres; and
hold the combination in a heated and pressurized state for a holding time sufficient to at least partially mineralize the PFAS to remove the PFAS from the adsorbent material; thereby regenerating the adsorbent media.

10. The system of claim 9, wherein the system includes a device for mixing the contents of the reactor.

11. The system of claim 9, wherein the system is configured to separate the regenerated adsorbent material from the mineralized PFAS.
